(19) United States
(12) Patent Application Publication
(10) Pub. No.: US 2019/0283978 A1
(43) Pub. Date: Sep. 19, 2019

(54) ONLINE MATERIAL MOISTURE MEASUREMENT SYSTEM AND METHOD THEREOF

(71) Applicant: FINETEK Co., Ltd., New Taipei City (TW)

(72) Inventors: Liang-Chi CHANG, New Taipei City (TW); Chien-Lung HUANG, New Taipei City (TW); Chao-Kai CHENG, New Taipei City (TW)

(21) Appl. No.: 15/920,442

(22) Filed: Mar. 13, 2018

(51) Int. Cl. B65G 47/76

(52) U.S. Cl. CPC B65G 47/763; G01N 21/85

(57) ABSTRACT

An online material moisture measurement system is provided. The online material moisture measurement system includes a fixed conveyor unit, a sensor and a constant-volume material guiding device. The fixed conveyor unit has a conveying side provided for passing a material. The sensor is installed onto the conveying side. A flow channel is formed between the constant-volume material guiding device and the fixed conveyor unit and has a material inlet and a material outlet. When the material enters into the material inlet and passes through the material outlet, the material has a volume greater than a lower limit and moves and passes through the sensor steadily. The material measured in a unit time can be situated at a stable state to improve the measurement precision.

### FIELD OF THE INVENTION

This disclosure relates to a moisture measurement system, and more particularly to an online material moisture measurement system and its method.

### BACKGROUND OF THE INVENTION

For materials such as cereals, feeds, or other industrial substances, etc, a very important procedure is required to measure the moisture content of these materials during harvest or manufacture. Accurate moisture content measurement data may be used as a reference for subsequent drying, storage, or manufacturing operations. As to cereals, the average moisture content is approximately 25% at harvest, and the moisture content may increase to a percentage up to 35% in rainy seasons. If the moisture content is not measured accurately when the cereals are purchased, the fairness of trade or the follow-up operations will be affected significantly.

Present online material moisture content measurement methods may be divided into capacitive, infrared, or microwave methods. With reference to FIGS. 1 and 2 for the cross-sectional view of a part of a conventional material moisture detection system and the chart of output readings of an experiment, the conventional material moisture detection system comprises a conveying device 10 (such as a conveyor belt) for transporting a material to be measured M and an online moisture meter 20 installed to the conveying device 10. During the transportation process, the material to be measured M can not be maintained stable in a unit time and/or a measuring range 30, so as to cause an inaccurate detection made by the online moisture meter 20 and fails to feedback any change of manufacturing conditions such as the material flow, volume, etc that results in damages or losses. As shown in FIG. 2, the deviation of the material reading tends to approach 10%.

Regardless of which online measurement method is used, a stable online transportation method is required, so that the material to be measured M can be situated at a stable flowing state in a unit time to reduce the measuring error and improve the accuracy and stability of the measurement.

In view of the aforementioned drawbacks of the prior art, the discloser of this disclosure based on years of experience to conduct extensive research and experiment, and finally provided a feasible solution to overcome the drawbacks of the prior art.

### SUMMARY OF THE INVENTION

Therefore, it is a primary objective of this disclosure to provide an online material moisture measurement system and its method, so that the material to be measured can be situated in a stable status in a unit time to improve the accuracy of the measurement.

To achieve the aforementioned and other objectives, this disclosure provides an online material moisture measurement system comprising a fixed conveyor unit, a sensor and a constant-volume material guiding device. The fixed conveyor unit has a conveying side provided for passing a material. The sensor is installed onto the conveying side of the fixed conveyor unit. The constant-volume material guiding device is installed adjacent to the sensor, and a flow channel is formed between the constant-volume material guiding device and the fixed conveyor unit. The flow channel has a material inlet and a material outlet, wherein when the material enters into the material inlet and passes through the material outlet, the material has a volume greater than a lower limit and moves and passes through the sensor steadily.

The constant-volume material guiding device of this disclosure can stabilize the online conveying process to improve the measurement precision of the sensor. In different embodiments, the constant-volume material guiding device may have a cross-section in the shape of an inclined plate, a raft plate, an upright plate or a plate in any other appropriate shape, so that the cross-sectional area of the material outlet is smaller than the cross-sectional area of the material inlet, or the width of the material inlet is greater than the width of the material outlet. When the sensor measures a material passing through the flow channel, the material at the material outlet can be situated at a steady flow state with a reduced flow rate and stacking effect.

To achieve the aforementioned and other objectives, this disclosure further provides an online material moisture measurement system comprising a fixed conveyor unit and a constant volume sensing device. The fixed conveyor unit has a conveying side provided for passing a material. The constant volume sensing device is installed onto an inner side of the conveying side and the constant volume sensing device includes a material guiding unit and a sensor built in the material guiding unit. The constant volume sensing device is installed in a flow channel for passing the material. An oblique angle is included between the material guiding unit and the fixed conveyor unit, and when the sensor measures the material passing through the oblique angle, the material has a volume greater than a lower limit and passes through the sensor steadily.

The major difference between this embodiment and the previous embodiment of this disclosure resides on that the sensor and the constant-volume material guiding device are integrated as a whole, and the constant volume sensing device is installed onto an inner side of the conveying side to simplify the installation procedure and reduce time. The oblique angle between the material guiding unit and the conveying side provides a stable flow effect by reducing the flow rate and stacking.

To achieve the aforementioned and other objectives, this disclosure provides an online material moisture measurement method comprising the steps of: providing a conveying side for passing a material; measuring the moisture content of the material by a sensor; and providing a constant-volume material guiding measure, so that the material has a volume per unit time greater than a lower limit and moves and passes through the sensor steadily.

### BRIEF DESCRIPTION OF THE DRAWINGS

FIG. 1 is a cross-sectional view showing a part of a conventional online material moisture detection system in accordance with a first embodiment of this disclosure;

FIG. 2 is a graph showing the output of experiment readings of a conventional online material moisture detection system;

FIG. 3 is a cross-sectional view of an online material moisture measurement system in accordance with a first preferred embodiment of this disclosure;

FIG. 4 is a graph showing the output of experiment readings of an online material moisture measurement system in accordance with the first preferred embodiment of this disclosure;

FIG. 5 is a cross-sectional view of an online material moisture measurement system in accordance with a second preferred embodiment of this disclosure;

FIG. 6 is a cross-sectional view of an online material moisture measurement system in accordance with a third preferred embodiment of this disclosure;

FIG. 7 is a cross-sectional view of an online material moisture measurement system in accordance with a fourth preferred embodiment of this disclosure; and

FIG. 8 is a flow chart of an online material moisture measurement method of this disclosure.

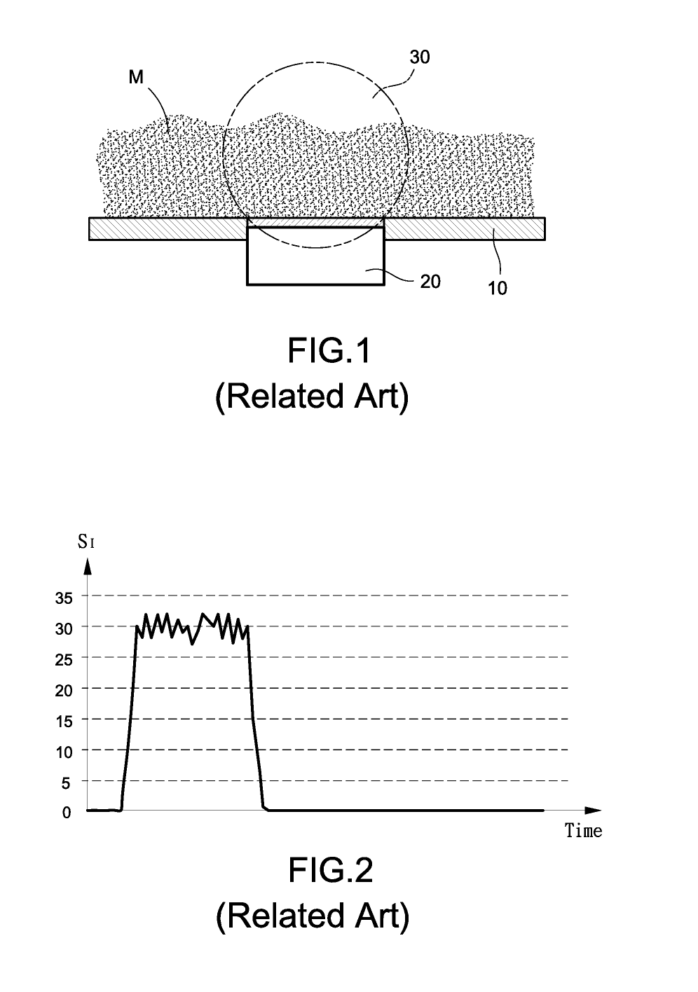

### DESCRIPTION OF THE PREFERRED EMBODIMENTS

The technical contents of this disclosure will become apparent with the detailed description of preferred embodiments accompanied with the illustration of related drawings as follows. It is intended that the embodiments and figures disclosed herein are to be considered illustrative rather than restrictive.

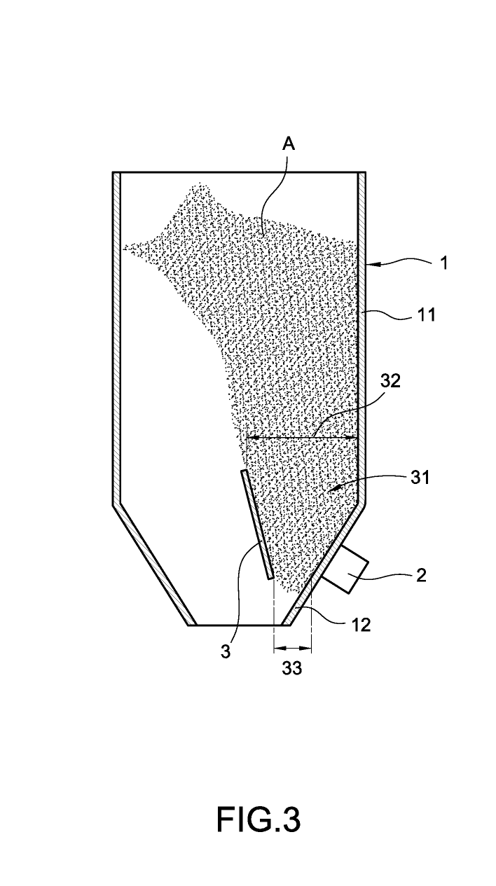

With reference to FIGS. 3 to 6 for the cross-sectional views of an online material moisture measurement system in accordance with the first to third preferred embodiments of this disclosure respectively, the online material moisture measurement system comprises a fixed conveyor unit 1, a sensor 2 and a constant-volume material guiding device 3. In these embodiments, the A material includes but not limited to those used in operations such as the production, manufacture or quality control in the areas of food, plastic, chemical engineering, medicine, environmental engineering, food trade, mining, construction, etc.

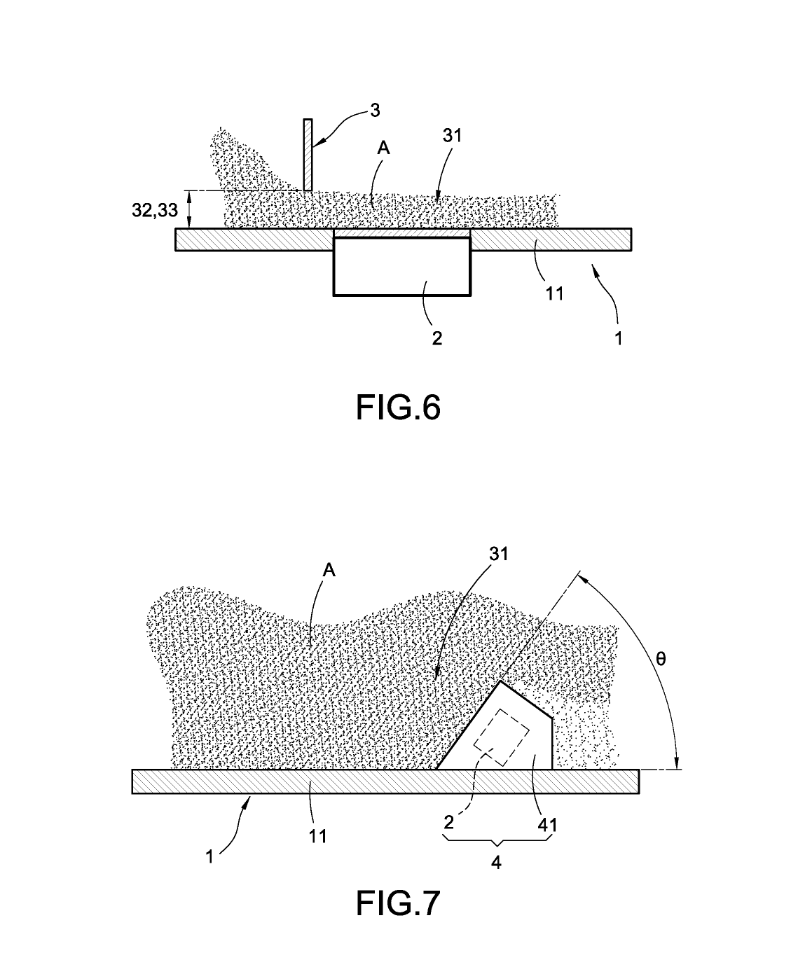

The fixed conveyor unit 1 has a conveying side provided for passing the material A. The sensor 2 is installed onto an outer side of the conveying side 11 of the fixed conveyor unit 1. In the first preferred embodiment as shown in FIG. 3, the fixed conveyor unit 1 may be a cylindrical groove, a connecting pipe or a grooved tube for conveying a material A indirectly, and the conveying side 11 may be an installation wall 12. In the second and third embodiments as shown in FIGS. 5 and 6 respectively, the fixed conveyor unit 1 is a conveyor belt for conveying the material A actively. Regardless of which fixed conveyor unit 1 is used, the sensor 2 detects the material A in a non-contact manner.

The constant-volume material guiding device 3 is installed adjacent to the sensor 2, and a flow channel 31 is formed between the constant-volume material guiding device 3 and the fixed conveyor unit 1. The flow channel 31 has a material inlet 32 and a material outlet 33, wherein when the material A enters into the material inlet 32 and passes through the material outlet 33, the material A has a volume greater than a lower limit and moves and passes through the sensor 2 steadily.

The constant-volume material guiding device 3 as shown in FIG. 3 is fixed in the fixed conveyor unit 1 and configured to be corresponsive to the sensor 2. The constant-volume material guiding device 3 of this embodiment is preferably an inclined plate. The material inlet 32 of the inclined plate is configured to be corresponsive to a feeding opening of the fixed conveyor unit 1, and the material outlet 33 of the inclined plate is configured to be corresponsive to a discharging opening of the fixed conveyor unit 1, so that the material inlet 32 has a width greater than (or equal to) the width of the material outlet 33. When the sensor 2 measures the material A passing through the flow channel 31, the material A at the material outlet 33 is in a steady flow state with a reduced flow rate and stacking effect, so that the material A measured in a unit time is situated at a steady state.

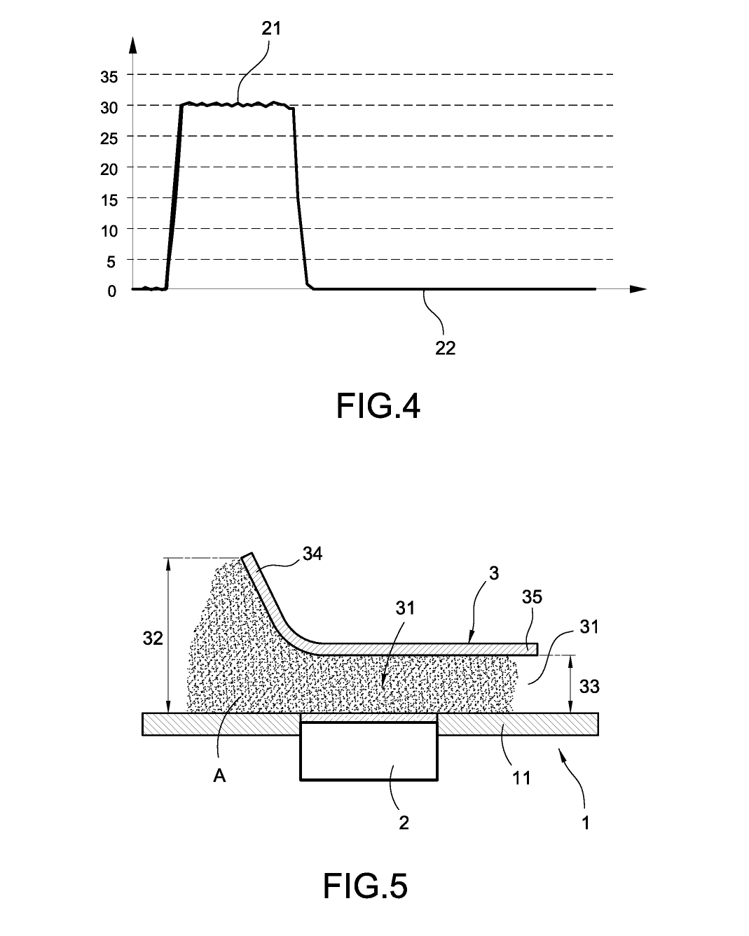

In the experiment readings as shown in FIG. 4, the Y-axis represents the signal intensity (Si) and the X-axis represents the time. In a unit time, the sensor 2 measures a material reading 21 and an empty bucket reading 22, wherein the material reading 21 has a signal deviation value effectively reduced to a range of 1-3% to improve the measurement precision.

In the second embodiment as shown in FIG. 5, the constant-volume material guiding device 3 is a raft plate. A cross-sectional end of the raft plate is a curved section 34, and the other end of the raft plate is a horizontal section 35, and the material inlet 32 is formed at the curved section 34, and the material outlet 33 is formed at the horizontal section 35, such that the material outlet 33 has a cross-sectional area smaller than (or equal to) the cross-sectional area of the material inlet 32, so as to achieve the same effect of having the material A at the material outlet 33 situated in a steady flow state with a reduced flow rate and stacking effect.

In the third embodiment as shown in FIG. 6, the constant-volume material guiding device 3 is an upright plate. The upright plate is configured to be perpendicular to the conveying side 11 of the fixed conveyor unit 1, and both of the material inlet 32 and the material outlet 33 are on the same side. The material A enters into the material inlet 32 by the guiding of the upright plate, the material A at the material outlet 33 is also situated at a steady flow state with a reduced flow rate and stacking effect.

The sensor 2 as shown in FIGS. 3, 5 and 6 includes but not limited to a capacitive, infra-red, radio-frequency, or microwave online moisture meter. Regardless of which kind of the sensor 2 with different measuring ranges, the constant-volume material guiding device 3 is capable of guiding the material A steadily, so that the water content of the detected material A passing through the sensor 2 in a unit time can be measured precisely to obtain an accurate measurement.

With reference to FIG. 7 for the cross-sectional view of the fourth preferred embodiment of this disclosure, this disclosure further provides an online material moisture measurement system comprising a fixed conveyor unit 1 and a constant volume sensing device 4. The fixed conveyor unit 1 has a conveying side A provided for passing the material A. The constant volume sensing device 4 is installed onto an inner side of the conveying side 11, and the constant volume sensing device 4 comprises a material guiding unit 41 and a sensor 2 built in the material guiding unit 41. The constant volume sensing device 41 is installed in a flow channel 31 which is provided for passing the material A. An oblique angle θ is formed between the material guiding unit 41 and the fixed conveyor unit 1. The oblique angle θ is preferably smaller than 90 degrees and greater than 30 degrees, so as to achieve the steady flow state with a reduced flow rate and stacking effect.

When the sensor 2 measures the material A passing through the oblique angle θ, the material A has a volume greater than a lower limit and passes through the sensor 2 steadily. In short, the main difference between the fourth embodiment and each of the aforementioned embodiments resides on that the sensor 2 is integrated with the constant-volume material guiding device 3, and the constant volume sensing device 4 is installed onto an inner side of the conveying side 11. The remaining structure and experimental measurement results are substantially the same as the aforementioned embodiments and thus will not be repeated.

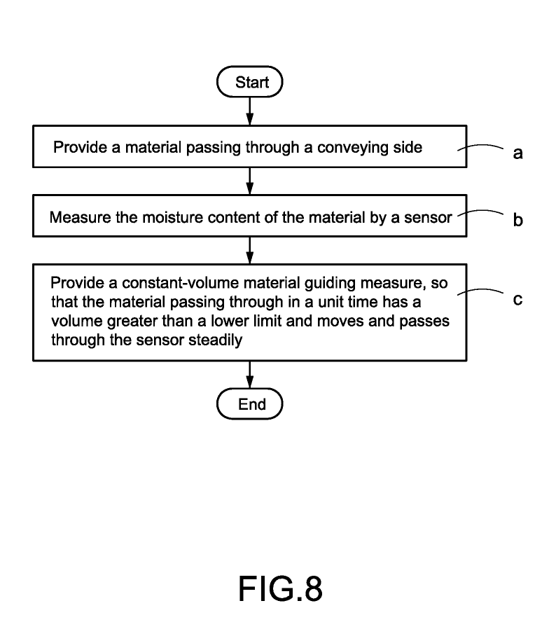

With reference to FIG. 8 for a flow chart of an online material moisture measurement method of this disclosure, the online material moisture measurement method comprises the following steps:

(a) Provide a material passing through a conveying side.

(b) Measure the moisture content of the material by a sensor.

(c) Provide a constant-volume material guiding measure, so that the material passing through in a unit time has a volume greater than a lower limit and moves and passes through the sensor steadily. It is noteworthy that the lower limit varies due to the specification and the sensing technology of the sensor, wherein the material passing through in a unit time has a lower limit of 1 cm³.

In the Step (a), the online material moisture measurement method is applied in the fixed conveyor unit such as a cylindrical groove, a connecting pipe, a conveyor belt or a grooved tube.

In the (Step b), the sensor is installed onto an outer side of the conveying side in a non-contact manner. In a different method, the sensor may be installed onto an inner side of the conveying side, as needed.

In the (Step c), the constant-volume material guiding measure comprises a constant-volume material guiding device installed with a spacing with respect to the conveying side for guiding the material, or a material guiding unit built in the sensor and disposed on an inner side of the conveying side and having an oblique angle included therein, so that the material can pass through the oblique angle steadily. In the measuring method with the design of separating the constant-volume material guiding device from the sensor, an is formed between the constant-volume material guiding device and the conveying side, and the flow channel has a material inlet and a material outlet, so that the material at the material outlet is in a steady flow state with a reduced flow rate and stacking effect. Therefore, when the sensor detects the water content of the material, an accurate measurement result of the material passing through the sensor in a unit time can be obtained.

While this disclosure has been described by means of specific embodiments, numerous modifications and variations could be made thereto by those skilled in the art without departing from the scope and spirit of this disclosure set forth in the claims.

What is claimed is:

1. An online material moisture measurement system, comprising:
a fixed conveyor unit, having a conveying side provided for passing a material;
a sensor, installed onto the conveying side of the fixed conveyor unit; and
a constant-volume material guiding device, installed adjacent to the sensor, and a flow channel being formed between the constant-volume material guiding device and the fixed conveyor unit, and the flow channel having a material inlet and a material outlet, wherein when the material enters into the material inlet and passes through the material outlet, the material has a volume greater than a lower limit and passes through the sensor steadily.

2. The online material moisture measurement system of claim 1, wherein the constant-volume material guiding device is fixed into the fixed conveyor unit, and the constant-volume material guiding device has a cross-section in the shape of an inclined plate, a raft plate or an upright plate.

3. The online material moisture measurement system of claim 2, wherein the material inlet of the inclined plate is configured to be corresponsive to a feeding opening of the fixed conveyor unit, and the material outlet of the inclined plate is configured to be corresponsive to a discharging opening of the fixed conveyor unit.

4. The online material moisture measurement system of claim 2, wherein the cross-section of the raft plate has an end which is a curved section, and the other end which is a horizontal section, and the curved section constitutes the material inlet, and the horizontal section constitutes the material outlet.

5. The online material moisture measurement system of claim 2, wherein the upright plate is configured to be perpendicular to the conveying side of the fixed conveyor unit, and both of the material inlet and the material outlet are situated on the same side.

6. The online material moisture measurement system of claim 1, wherein the material outlet has a cross-sectional area smaller than or equal to the cross-sectional area of the fixed conveyor unit, and the material inlet has a width greater than or equal to the width of the material outlet.

7. The online material moisture measurement system of claim 1, wherein the conveying side is an installation wall of the fixed conveyor unit which sensor can sense.

8. The online material moisture measurement system of claim 1, wherein when the sensor measures the material passing through the flow channel, the material at the material outlet is in a steady flow state with a reduced flow rate and stacking effect.

9. The online material moisture measurement system of claim 1, wherein the fixed conveyor unit is a cylindrical groove, a connecting pipe, or a conveyor belt, and the sensor is based on capacitive, infrared, radio-frequency or microwave principle developed online moisture meter.

10. An online material moisture measurement system, comprising:
a fixed conveyor unit, having a conveying side provided for passing the material; and
a constant volume sensing device, installed onto an inner side of the conveying side, and including a material guiding unit and a sensor built in the material guiding unit, and the constant volume sensing device being installed in a flow channel for passing the material; wherein an oblique angle is included between the material guiding unit and the fixed conveyor unit, and when the sensor measures the material passing through the oblique angle, the material has a volume greater than a lower limit and passes through the sensor steadily.

11. An online material moisture measurement method, comprising the steps of:
providing a material passing though a conveying side;
measuring the moisture content of the material by a sensor; and
providing a constant-volume material guiding measure, such that the volume of the material per unit time is greater than a lower limit, and the material moves and passes through the sensor steadily.

12. The online material moisture measurement method of claim 11, wherein the step of providing a constant-volume material guiding measure further comprises the step of installing a constant-volume material guiding device with a spacing from the corresponding conveying side to guide the material.

13. The online material moisture measurement method of claim 12, further comprising a flow channel formed between the constant-volume rate material guiding device and the conveying side, and the flow channel having a material inlet and a material outlet, so that the material at the material outlet is situated at a steady flow state with a reduced flow rate and stacking effect, which the said sensor is detected.

14. The online material moisture measurement method of claim 11, wherein the step of providing a constant-volume material guiding measure further comprises the step of installing a material guiding device with the built-in sensor on an inner side of the conveying side and an oblique angle included therebetween, so as to pass the material through the oblique angle.
